(19) United States
(12) Patent Application Publication
(10) Pub. No.: US 2012/0273538 A1
(43) Pub. Date: Nov. 1, 2012

(54) AUTOMOBILE WITH A BICYCLE CARRIER

(75) Inventor: Burkhard RICHTER, Schwabenheim (DE)

(73) Assignee: GM GLOBAL TECHNOLOGY OPERATIONS LLC, Detroit, MI (US)

(21) Appl. No.: 13/458,807

(22) Filed: Apr. 27, 2012

(30) Foreign Application Priority Data
Apr. 29, 2011 (DE) 10 2011 100 007.4

(51) Int. Cl. B60R 9/06

(52) U.S. Cl. 224/485

(57) ABSTRACT

An automobile has a bracket, a storage device configured to receive luggage, and a fastening device that connects the bracket and the storage device. The bracket is configured as a bicycle carrier on a rear of the automobile.

### CROSS-REFERENCE TO RELATED APPLICATION

This application claims priority to German Patent Application No. 10 2011 100 007.4, filed Apr. 29, 2011, which is incorporated herein by reference in its entirety.

### TECHNICAL FIELD

The technical field generally relates to automobiles and more particularly relates to automobiles having a bracket and a storage device to receive luggage, wherein the bracket and the storage device are connected with each other by a fastening device.

### BACKGROUND

From U.S. Pat. No. 5,586,702 A and U.S. Pat. No. 6,845,895 B2 it is already known to arrange storage devices at the rear of an automobile. Against this background, U.S. Pat. No. 6,845,895 B2 teaches to equip a storage device with a ski carrier and to position the unit which is thus created on the rear end of an automobile. Furthermore, U.S. Pat. No. 5,586,702 A teaches to arrange a storage device in the region the rear bumper of an automobile using its trailer hitch. It is disadvantageous here that the automobiles must be equipped with a trailer hitch in order to receive the storage device. Storage devices are also known which can be mounted onto a roof luggage carrier. However, these have to be mounted in a laborious manner and are therefore not suitable for everyday use.

A need therefore exists for a storage device that easily can be used every day. When the storage device is installed, the use of the trunk of the automobile should be virtually unimpaired. In addition, a need exists for a storage device that is accessible without difficulty in the installed state. In particular, the storage device should be able to be opened without difficulty and should only give rise to a small loading height. Furthermore, a need exists for a storage device that is easy to transport once removed from the automobile.

### SUMMARY

An automobile comprising a bracket and a storage device to receive luggage is provided. The bracket and the storage device are connected and/or coupled to each other by a fastening device. The bracket is configured as a bicycle carrier on the rear of the automobile.

In an exemplary embodiment, the storage device is arranged or respectively fastened on the rear bicycle carrier of a passenger-conveying automobile to enable an everyday and mobile use thereof. The everyday and mobile use is enabled by a fastening device that is able to be released and locked quickly and without difficulty. Such a storage device can be utilized without difficulty in everyday use because the bicycle carrier is present in any case. In an exemplary embodiment, the storage device can be selected to be large enough to receive usual quantities of groceries of a one- or two-person household. In particular, two drinks crates can be held in the storage device. Nevertheless, the storage device is compact, such that it can be handled relatively easily. The storage device is somewhat wider than the bicycle carrier, but only has a small loading height. As the storage device can be removed from the bicycle carrier quickly and without tools, it is ensured that the trunk remains able to be used without difficulty.

According to an embodiment, the bicycle carrier is able to be folded down together with the storage device or to be removed from the vehicle body. Through this step, the trunk is accessible particularly quickly and without difficulty.

The bicycle carrier is arranged displaceably on the vehicle body. In this regard, the bicycle carrier is able to be drawn out from and pushed into the vehicle body in the manner of a drawer. The storage device hereby displays a high degree of functionality with a high suitability for everyday use. It is arranged such that the trunk of the automobile can be used, although the storage device is installed on the automobile.

In an exemplary embodiment, the bicycle carrier is a Flex-Fix bicycle carrier available from Adam Opel AG of Germany and the storage device is able to be fastened on or respectively removed from the Flex-Fix bicycle carrier in a quick and simple manner. The Flex-Fix bicycle carrier is able to be drawn out in the manner of drawer at the rear end of an automobile from its automobile body. The storage device is able to be transported and stored without difficulty in the fastened state on the Flex-Fix bicycle carrier. The storage device is very readily accessible, is able to be opened without difficulty, and only give rise to a small loading height.

Against this background, according to a further embodiment, the bicycle carrier is able to be drawn out from the vehicle body together with the license plate. The bicycle carrier can therefore be held in the vehicle body such that no intrusive parts of the bicycle carrier project from the vehicle body.

The storage device is configured as a component that complements structurally with the vehicle body. The storage device preferably also sets itself apart from the remainder of the automobile in that it is manufactured from high-grade materials such as aluminum or plastics.

According to an embodiment, the storage device has a wheel arrangement that is able to be folded in and/or out. An everyday and mobile use is ensured by an integrally constructed wheel arrangement that is able to be folded in and out. Hereby, a convenient and difficulty-free transportation of the storage device is made possible. The storage device can be moved both towards the automobile and also removed therefrom. A loading or unloading of the storage device is possible both on the automobile and off the automobile.

Against this background, according to a further embodiment, the wheel arrangement is folded out automatically when the storage device is moved relative to the bracket. Through a wheel arrangement, which is able to be folded out automatically on a movement of the storage device relative to the bracket, the storage device can be brought particularly quickly and without difficulty into a state which is capable of rolling.

According to another embodiment, the storage device has a lever by which the wheel arrangement is able to be folded in and/or out. At the same time, the lever can be used as a handle in order to grasp the storage device. The wheel arrangement can be folded out or in on gripping of the storage device.

In this regard, according to a further embodiment, the wheel arrangement has two wheel sets, wherein the wheel sets are able to be folded in and/or out in succession by actuating the lever. Through this actual embodiment, the storage device can be drawn down from the bicycle carrier and initially supported onto a first wheel set. Thereafter, a second wheel set can be folded out, on which the storage device can roll.

According to an embodiment, the fastening device comprises guide rails and fixing tubes on the bicycle carrier and fixing bars on the storage device. The fixing bars can be directed by the guide rails to the fixing tubes. Hereby, the storage device is reliably guided on the bicycle carrier.

Against this background, according to another embodiment, the fixing bars are held in a sliding manner in the fixing tubes. Hereby, it is ensured that the storage device is fixed on the bicycle carrier in two spatial directions.

According to a further embodiment, the fastening device has a locking wheel. A locking wheel can fix the storage device in a spatial direction. The locking wheel can be rotatable about a pin such that the storage device is fixed so as to be non-displaceable in a spatial direction. The pin can be surrounded by the locking wheel, wherein the locking wheel is mounted rotatably on the pin.

According to a further embodiment, the locking wheel is rotatable by the lever, wherein on rotation of the locking wheel a wheel set is able to be folded in or out. In this regard, the storage device is unlocked at the same time and is brought into a state that is partially capable of rolling.

According to another embodiment, the storage device is able to be locked and/or unlocked by a car key. The storage device can be locked and/or unlocked with the same key with which the engine of the automobile can be started in order to be guided down from the bicycle carrier or fixed thereon. Against this background, the storage device can be opened and/or closed by a car key. The storage device can be opened by the same key by which the engine of the automobile can be started, such that the cover of the storage device is able to be swiveled.

According to an embodiment, the storage device is water-tight. Hereby, it can also be used on journeys in the rain.

Rear lights are able to be mounted on the bicycle carrier in one embodiment. In this regard, other road users can be alerted to the projecting bicycle carrier in addition to the storage device. The rear lights are able to be secured on the bicycle carrier by a reversibly detachable detent-, plug-, push- or clip connection, when the bicycle carrier is drawn out from the vehicle body. The rear lights can be removed as soon as the bicycle carrier is pushed back into the vehicle body. The removed rear lights can be held inside the drawer-like bicycle carrier and can be countersunk therewith in the vehicle body.

The storage device can be used as a shopping cart, as a suitcase, as a tool box, for the storage of musical instruments, in particular of guitars, for the storage of smaller bicycles, sports equipment, in particular of golf clubs and snowboards, strollers, wheelchairs, computers, and articles of clothing.

In addition, other objects, desirable features and characteristics will become apparent from the subsequent detailed description, and the appended claims, taken in conjunction with the accompanying drawings and this summary.

### BRIEF DESCRIPTION OF THE DRAWINGS

The various embodiments will hereinafter be described in conjunction with the following drawing figures, wherein like numerals denote like elements and wherein:

FIG. 1 is a side view of an automobile with a storage device mounted on a bicycle carrier, wherein it is illustrated that the rear flap of the automobile does not collide with the storage device on folding open;

FIG. 2 is a side view of the automobile according to FIG. 1, wherein the cover of the storage device is able to be folded open such that it does not collide with the closed rear flap;

FIG. 3 is a side view of the automobile according to FIG. 1, wherein the opened storage device has a large opening angle; furthermore it is illustrated that the storage device only gives rise to a small loading height;

FIG. 4 is a side view of a storage device which has a handle and can be used as a shopping cart;

FIG. 5 shows in two side views, the automobile according to FIG. 1 with the storage device, in which a lever is able to be grasped via the handle, in order to fold out a first wheel set and to uncouple the storage device from the bicycle carrier;

FIG. 6 shows in an upper view, that the lever is able to be further swiveled in order to fold out a second wheel set and to draw the storage device down from the bicycle carrier, and in a lower view the storage device in the state released from the bicycle carrier;

FIG. 7 is a side view illustrating a storage device that is able to be opened and closed by a car key;

FIG. 8 shows a sectional view of the storage device, wherein it is illustrated that the fastening device comprises guide rails and fixing tubes on the bicycle carrier and fixing bars on the storage device;

FIG. 9 shows in an upper view the storage device in its fixed final position and in a lower view the fastening device in a sectional view;

FIG. 10 shows in several views the locking and unlocking of the storage device on the bicycle carrier; and

FIG. 11 shows in a diagrammatic view several positions of a locking wheel, by which the storage device is able to be fixed on the bicycle carrier.

### DETAILED DESCRIPTION

The following detailed description is merely exemplary in nature and is not intended to limit the application and uses of the various embodiments. Furthermore, there is no intention to be bound by any theory presented in the preceding background or the following detailed description

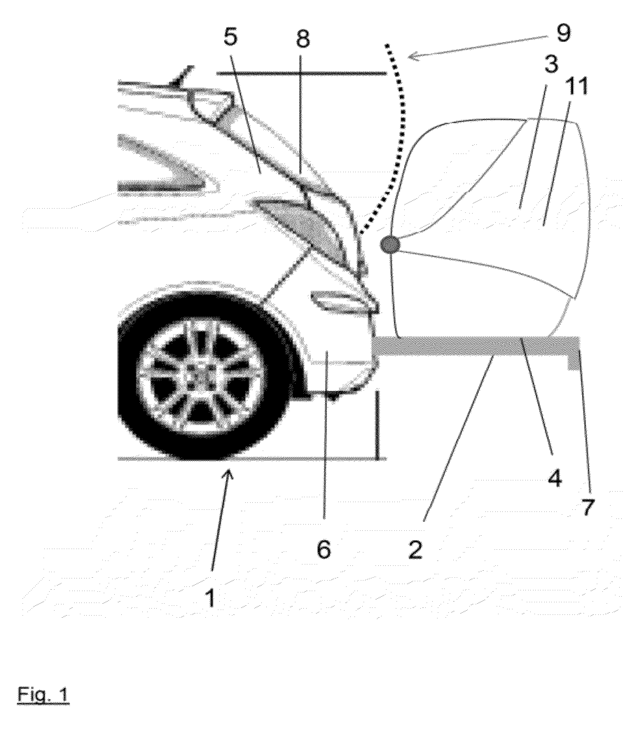

FIG. 1 shows an automobile 1, comprising a bracket 2 and a storage device 3 to receive luggage, wherein the bracket 2 and the storage device 3 are connected with each other by a fastening device 4. The bracket 2 is configured as a bicycle carrier on the rear 5 of the automobile 1.

The bicycle carrier is arranged displaceably on the vehicle body 6, wherein the bicycle carrier is able to be drawn out from and pushed into the vehicle body 6 in the manner of a drawer. The bicycle carrier is able to be drawn out from the vehicle body 6 together with the license plate 7.

FIG. 1 shows the ideal case that the rear flap 8 of the automobile 1 does not collide with the storage device 3 on folding open. The curve 9 described by the outermost end of the rear flap 8 on folding open is represented by dashed lines.

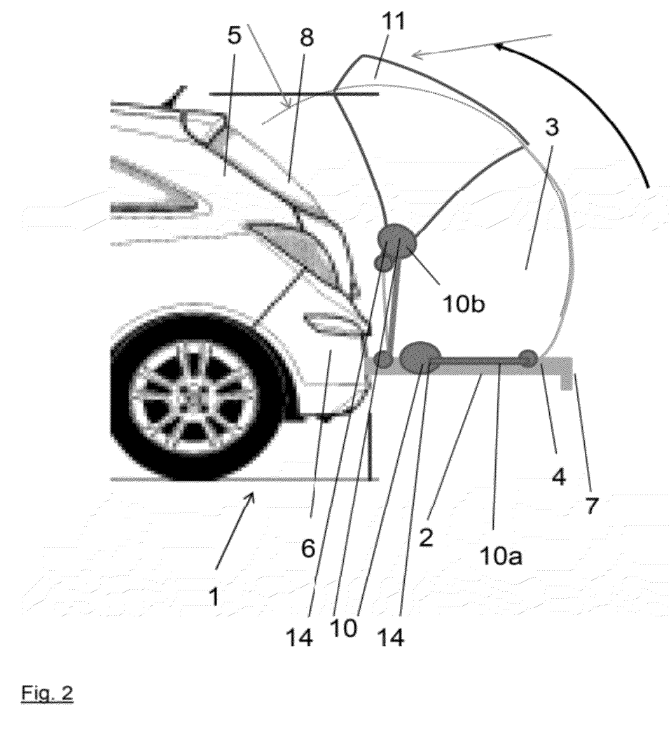

Referring to FIG. 2, the storage device 3 has a wheel arrangement 10 that is able to be folded in and/or out. The cover 11 of the storage device 3 is able to be folded open such that it does not collide with the closed rear flap 8. A central brake light can be provided above the storage device 3 instead of a lower-lying brake light.

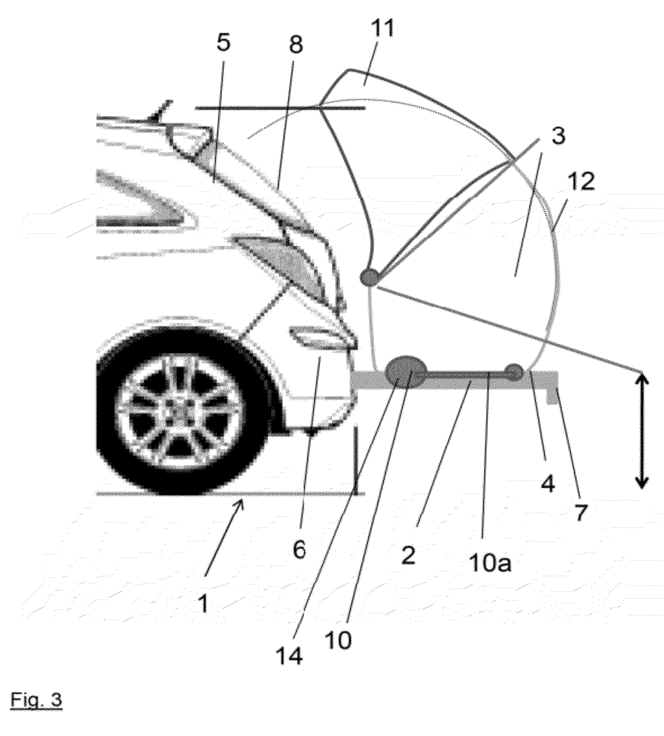

The opened storage device 3 has a large opening angle 12, as illustrated in FIG. 3. Furthermore, the storage device 3 only gives rise to a small loading height. The storage device 3 is somewhat wider than the bicycle carrier. Rear lights, which are not illustrated, are arranged on the bicycle carrier.

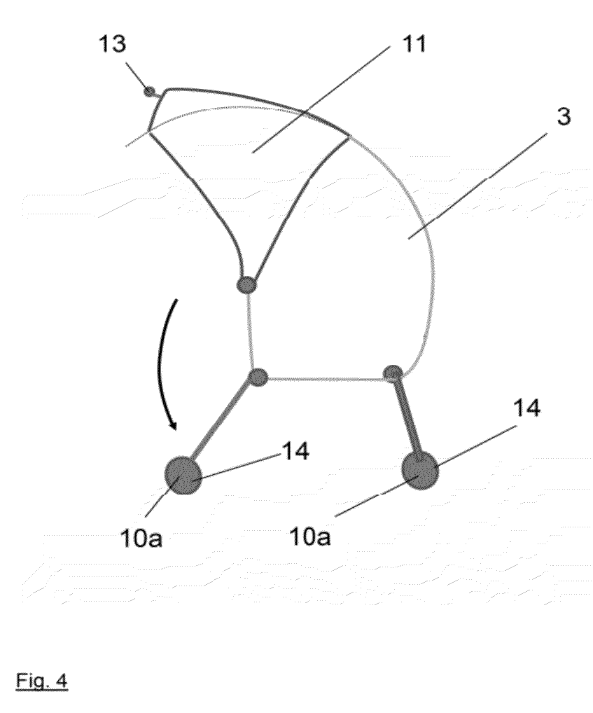

FIG. 4 shows that the storage device 3 has a handle that is configured as a lever 13. The storage device 3 has, in addition, wheels 14 of wheel arrangement 10. The storage device 3 can therefore be used as a shopping cart and can be grasped by the handle without difficulty.

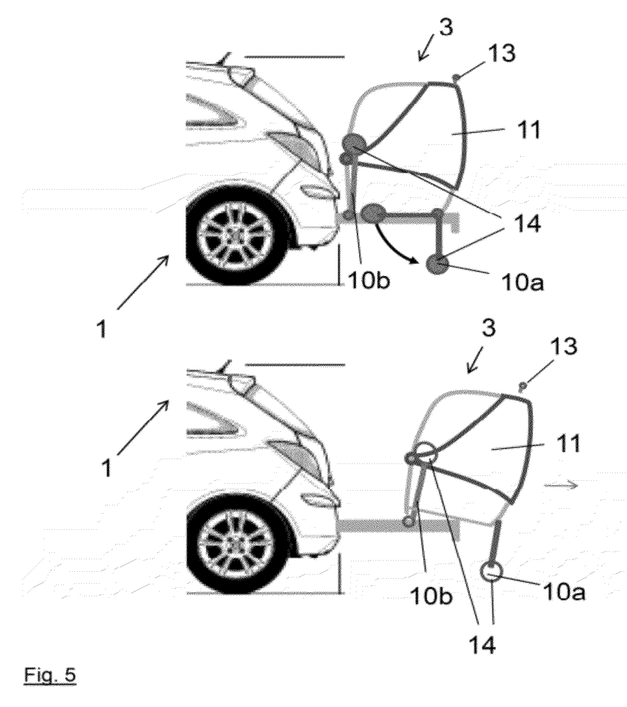

Referring to FIG. 5, the lever 13 can be used to fold the wheel arrangement 10 in and/or out. The wheel arrangement 10 has two wheel sets 10a, 10b, wherein the wheel sets 10a, 10b are able to be folded in and/or out in succession by actuating of the lever 13. FIG. 5 shows in an upper view that the lever 13 or respectively the handle is able to be grasped in order to fold out a first wheel set 10a and to uncouple the storage device 3 from the bicycle carrier. The lower view of FIG. 5 shows that the storage device 3 is able to be easily inclined and able to be drawn down towards the rear from the bicycle carrier.

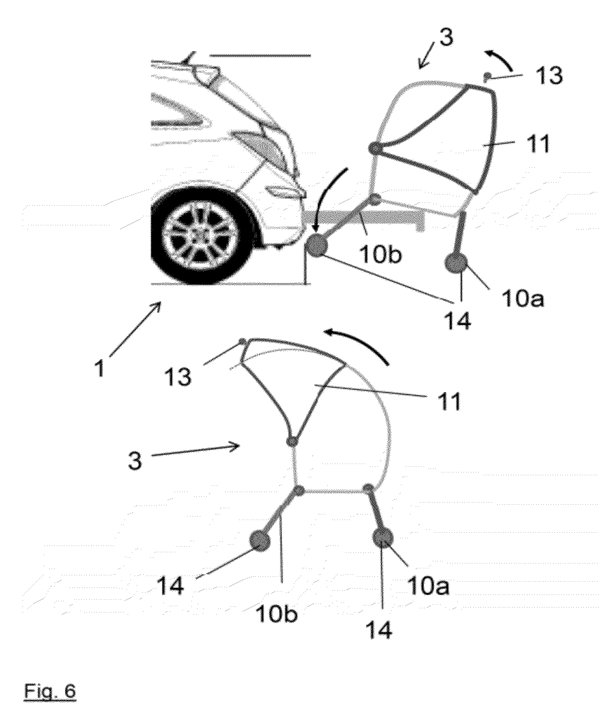

FIG. 6 shows in an upper view that the lever 13 is able to be further swiveled in order to fold out a second wheel set 10b and to draw the storage device 3 down from the bicycle carrier. The folding out of the second wheel set 10b could, however, also take place automatically without further swiveling of the lever 13. This automatic process could be initiated by a movement of the storage device 3 relative to the bicycle carrier.

FIG. 6 shows in the lower view that the cover 11 is opened and fixed. The storage device 3 can be used as a shopping cart or a suitcase, in particular a rollable suitcase. The storage device can also be used as a tool cabinet or a computer service station.

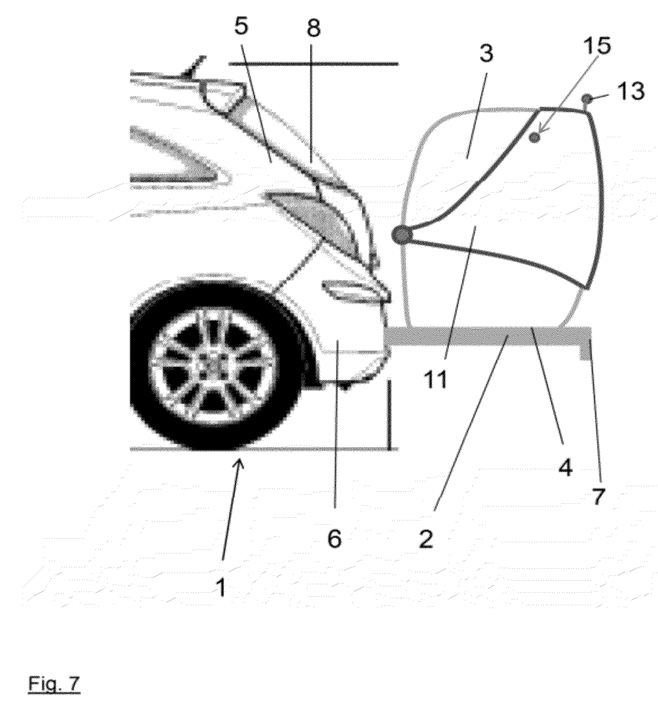

Referring to FIG. 7, the storage device 3 is able to be locked and/or unlocked and able to be opened and/or closed by a car key 15, that is, a key that actuates the motor of the automobile. The storage device 3 is advantageously water-tight. The wheel arrangement 10 is in folded-in state.

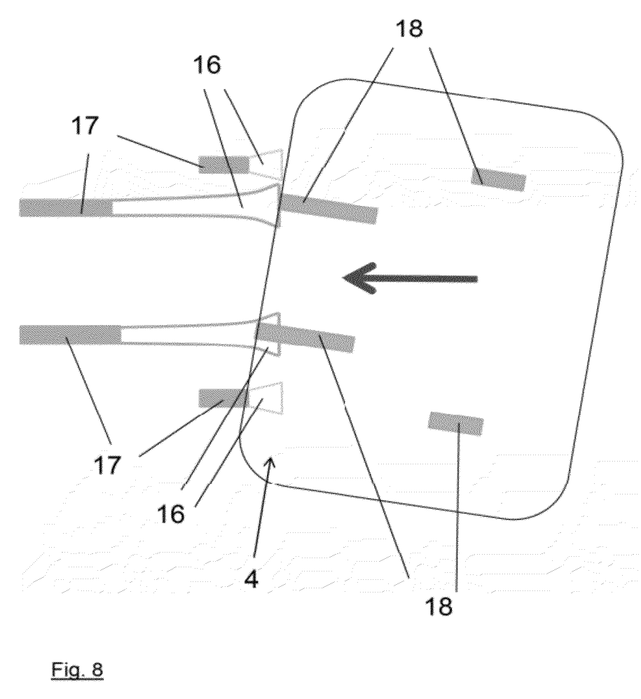

FIG. 8 shows that the fastening device 4 comprises guide rails 16 and fixing tubes 17 on the bicycle carrier and fixing bars 18 on the storage device 3. The fixing bars 18 slide into the fixing tubes 17. The guide rails 16 ensure a problem-free sliding into each other of the fixing tubes 17 and fixing bars 18, even when the fixing tubes 17 and fixing bars 18 initially form an angle. The fixing bars 18 are constructed on the floor of the storage device 3.

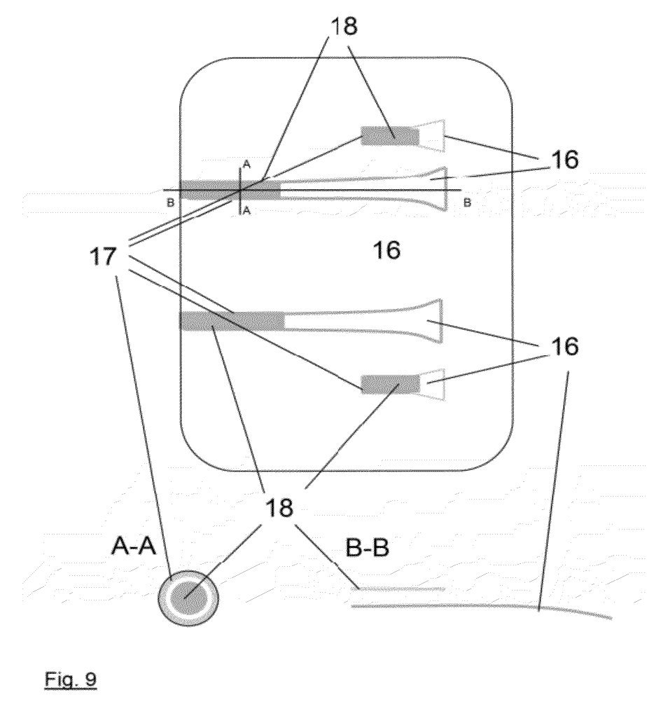

FIG. 9 shows that the fixing bars 18 are received in a sliding manner in the fixing tubes 17.

FIG. 9 shows in an upper view the fastening device 4 in a top view, wherein the storage device 3 is situated in its fixed final position. The storage device 3 is fixed in two spatial directions on the bicycle carrier, wherein the spatial directions extend along the height and the width of the automobile 1.

In a lower left-hand view, FIG. 9 shows the section A-A in an enlarged representation. It is illustrated there that the fixing bars 18 are received concentrically in the fixing tubes 17. In a lower right-hand view, FIG. 9 shows the section B-B in an enlarged representation. It is illustrated there that the guide rails 16 have a curved, widened section which continues into a section that is parallel to the fixing tubes 17.

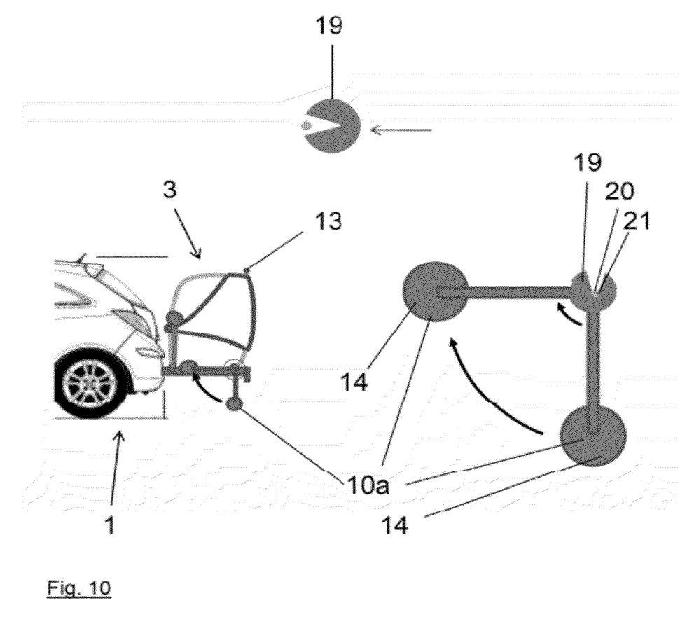

FIG. 10 shows in an upper view that the fastening device 4 has a locking wheel 19. FIG. 10 shows in the right-hand view that the locking wheel 19 is rotatable about a pin 20 such that the storage device 3 is fixed non-displaceably in a spatial direction.

FIG. 10 shows in the left-hand view diagrammatically that the locking wheel 19 is rotatable by the lever 13, wherein on rotation of the locking wheel 19 a wheel set 10a is able to be folded in and/or out. FIG. 10 shows in the left-hand view diagrammatically the locking and unlocking of the storage device 3 on the bicycle carrier. After the storage device 3 is fixed in its final position on the bicycle carrier in two spatial directions, it can be locked in a third spatial direction. This can take place by rotating the locking wheel 19, which is arranged on the storage device 3 and surrounds a stationary pin 20, which is fastened to the bicycle carrier. The rotating of the locking wheel 19 can take place together with the movement of the wheel set 10a of the storage device 3. This is illustrated in particular in the right-hand view of FIG. 10. When the storage device 3 is secured on the bicycle carrier, the locking wheel 19, which is fastened on the rotation axis 21 of the first wheel set 10a of the storage device 3, slides in the direction of the pin 20, which projects out from the bicycle carrier. By the first wheel set 10a being swiveled upwards, the locking wheel 19 embraces the pin 20 and locks the storage device 3 on the bicycle carrier. The storage device 3 is hereby fixed. In the direction of the height and width of the automobile 1 the storage device 3 is fixed by the system of fixing bars 18 and fixing tubes 17 which are described above. The locking wheel 19 therefore fixes the storage device 3 only in the longitudinal direction of the automobile 1.

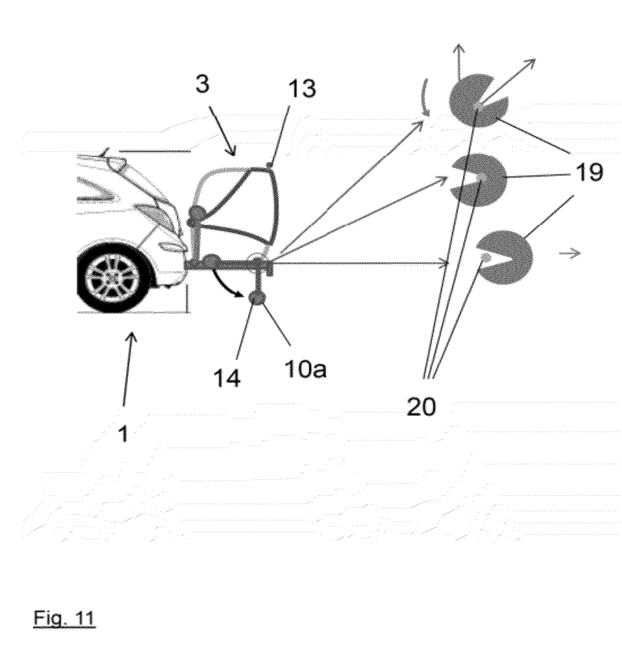

FIG. 11 shows the locking and unlocking of the storage device 3 on the bicycle carrier in a diagrammatic view. By the swiveling of the first wheel set 10a the locking wheel 19 is rotated, which is connected with the first wheel set 10a. The pin 20 is fastened on the bicycle carrier. The storage device 3 is fixed by the pin 20. Hereby, the storage device 3 is securely connected with the bicycle carrier. When the first wheel set 10a is swiveled downwards, the storage device 3 is released from the bicycle carrier. The storage device 3 can then be drawn towards the rear, in order to remove it from the bicycle carrier.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An automobile comprising:
a bracket;
a storage device configured to receive luggage; and
a fastening device that connects the bracket and the storage device,
wherein the bracket is configured as a bicycle carrier on a rear of the automobile.

2. The automobile according to claim 1, wherein the bicycle carrier is configured to fold down together with the storage device and/or be removed from the automobile.

3. The automobile according to claim 1, wherein the bicycle carrier is arranged displaceably on the automobile, and wherein the bicycle carrier is configured to be drawn out from and pushed into the automobile in the manner of a drawer.

4. The automobile according to claim 3, wherein the bicycle carrier is configured to be drawn out from the automobile together with a license plate of the automobile.

5. The automobile according to claim 1, wherein the storage device has a wheel arrangement that folds in and/or out.

6. The automobile according to claims 5, wherein the storage device has a lever by which the wheel arrangement folds in and/or out.

7. The automobile according to claim 6, further comprising the wheel arrangement that folds out automatically on a movement of the storage device relative to the bracket.

8. The automobile according to claim 6, wherein the wheel arrangement has two wheel sets, wherein the wheel sets fold in and/or out in succession by actuating of the lever.

9. The automobile according to claim 1, wherein the fastening device comprises guide rails and fixing tubes on the bicycle carrier and fixing bars on the storage device.

10. The automobile according to claim 9, wherein the fixing bars are received in a sliding manner in the fixing tubes.

11. The automobile according to claim 1, wherein the fastening device has a locking wheel.

12. The automobile according to claim 11, wherein the locking wheel is rotatable about a pin such that the storage device is fixed non-displaceably in a spatial direction.

13. The automobile according to claim 11, wherein the locking wheel is rotatable by a lever, wherein on rotation of the locking wheel a wheel set of the storage device is able to be folded in and/or out.

14. The automobile according to claim 1, wherein the storage device is able to be locked and/or unlocked and/or opened and/or closed by a car key.

15. The automobile according to claim 1, wherein the bicycle carrier is configured such that rear lights are removably mounted thereon.
